(19) United States
(12) Patent Application Publication
(10) Pub. No.: US 2015/0276060 A1
(43) Pub. Date: Oct. 1, 2015

(54) SELF-HEALING MATE LINE FOR MODULAR PANELING

(71) Applicant: M.G. McGrath, Inc., Maplewood, MN (US)

(72) Inventor: Michael McGrath, Maplewood, MN (US)

(73) Assignee: M.G. McGrath, Inc., Maplewood, MN (US)

(21) Appl. No.: 14/224,810

(22) Filed: Mar. 25, 2014

(51) Int. Cl. F16J 15/02

(52) U.S. Cl. CPC F16J 15/028; F16J 15/022

(57) ABSTRACT

A flexible seal assembly can include a base region coupled to a first seal region defining a hollow cavity, the first seal region having a profile including a cross sectional width that is tapered in a tapered-width region near the base region to be thicker than in a distal region extending outwards from the base region. The profile of the first seal region can include a curved face in a region exterior to the first hollow cavity in the distal region extending outwards from the base region, and the profile of the first seal region includes flat faces in the region exterior to the first hollow cavity in the tapered-width region. A system such as a modular panel assembly or frame-and-seal arrangement of a modular panel system can include a first frame assembly including a channel sized and shaped to receive a retention feature of the first seal assembly.

### BACKGROUND

Building construction techniques have evolved to meet stringent demands regarding limiting cost, limiting fabrication complexity, and enhancing longevity. Modular paneling systems can help to meet these challenges, such as by leveraging design and fabrication effort in a manner that allows prefabrication of the panels and re-use of a variety of standardized modular panel components across a structure or series of structures. In particular, use of interior and exterior modular paneling systems can offer flexibility to designers seeking to combine various materials in a manner that is both attractive and functional. In one approach, such paneling systems can be fabricated from base materials on-site in a piece-by-piece manner, such as including assembly of frame or support members, cladding or attachment of paneling to such members, hanging or installation of panel assemblies on the structure, and ensuring that such assemblies are weather-proof after installation.

### OVERVIEW

The present inventor has recognized, among other things, that significant economies of scale can be realized through the use of pre-fabricated modular paneling to facilitate rapid assembly of building structures. For example, portions of building can be clad by an array of pre-fabricated modular panel assemblies including a desired configuration of glazing or solid materials, or combinations thereof, and a supporting frame structure for such paneling. Such pre-fabricated panel assemblies can include multiple layers of material having a desired stack-up to meet aesthetic and environmental performance specifications.

One challenge posed by such pre-fabricated panels is providing a weather-tight seal without requiring careful alignment or difficult assembly procedures. Moreover, such a seal is generally specified to maintain performance over a wide range of temperatures (and in view of resulting displacements imparted on the modular panel system such as due to thermal expansion or contraction, or motion of the structure due to wind loading, for example), with minimal or no maintenance after installation. The present inventor has, among other things, developed an innovative seal configuration. For example, such a seal configuration can maintain a weather-proof seal along a mating line between adjacent pre-fabricated panels under a variety of conditions, such as after the panels are installed as a portion of a structure. For example, pre-fabricated panels in an array can each include a frame structure, such as including an extruded profile having one or more thermal breaks, along with a seal around the perimeter of each frame structure.

Such a seal can be elastic and can include a hollow interior region having a curved profile in an outer region of the seal, and linear faces in a region nearer the base of the seal. A width of the wall of the hollow interior region can be tapered to become thicker (e.g., less flexible or compressible) nearer the base of the seal as compared to the region of the seal near an interface with a mating surface on an adjacent panel. In an example, the seal can include two interior regions having similar profiles by laterally spaced apart to provide redundancy and to further improve performance in conditions such as during exposure to high winds, or to improve performance when adjacent panels are displaced or otherwise shifted with respect to each other.

In an example, a flexible seal assembly can include a base region coupled to a first seal region defining a hollow cavity, the first seal region having a profile including a cross sectional width that is tapered in a tapered-width region near the base region to be thicker than in a distal region extending outwards from the base region. The profile of the first seal region can include a curved face in a region exterior to the first hollow cavity in the distal region extending outwards from the base region, and the profile of the first seal region includes flat faces in the region exterior to the first hollow cavity in the tapered-width region.

In an example, a system such as a modular panel assembly or frame-and-seal arrangement of a modular panel system can include a first frame assembly including a channel sized and shaped to receive a retention feature of the first seal assembly and configured to inhibit the first seal assembly from detaching from the first frame assembly when the seal is displaced in at least one axis, the first frame assembly configured to couple to a panel.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates generally an example of a cross-sectional profile of a flexible seal, such as be included as a portion of a modular panel assembly.

FIG. 1B illustrates generally an example of a cross-sectional profile of a flexible seal, similar to the seal of FIG. 1A but including an illustrative example of a retention feature different from that shown in the example of FIG. 1A.

FIG. 2 illustrates generally an example of a cross-sectional profile of a flexible seal, such as including first and second seal regions, and respective retention features.

FIG. 3 illustrates generally an example of a cross-sectional view of a system that can include two frame structures configured to retain respective flexible seals.

FIG. 4 illustrates generally an example of a cross-section view of a system that can include two frame structures configured to retain respective flexible seals.

FIGS. 5A through 5D illustrate various relative alignments of a system that can include two frame structures configured to retain respective flexible seals.

FIGS. 6A through 6D illustrate generally an example of a various views of a corner flexible seal assembly, and FIG. 6E illustrates generally an example of a cross-section view of such a corner flexible seal assembly, such as can be used to provide a weather-tight seal at a corner transition of a panel assembly, such as mating with respective flexible seal regions as shown in one or more of the examples of FIG. 1A, 1B, 2, 3, 4, or 5A through 5D.

FIG. 7 illustrates generally a technique, such as a method, that can include coupling a flexible seal assembly to a frame assembly.

### DETAILED DESCRIPTION

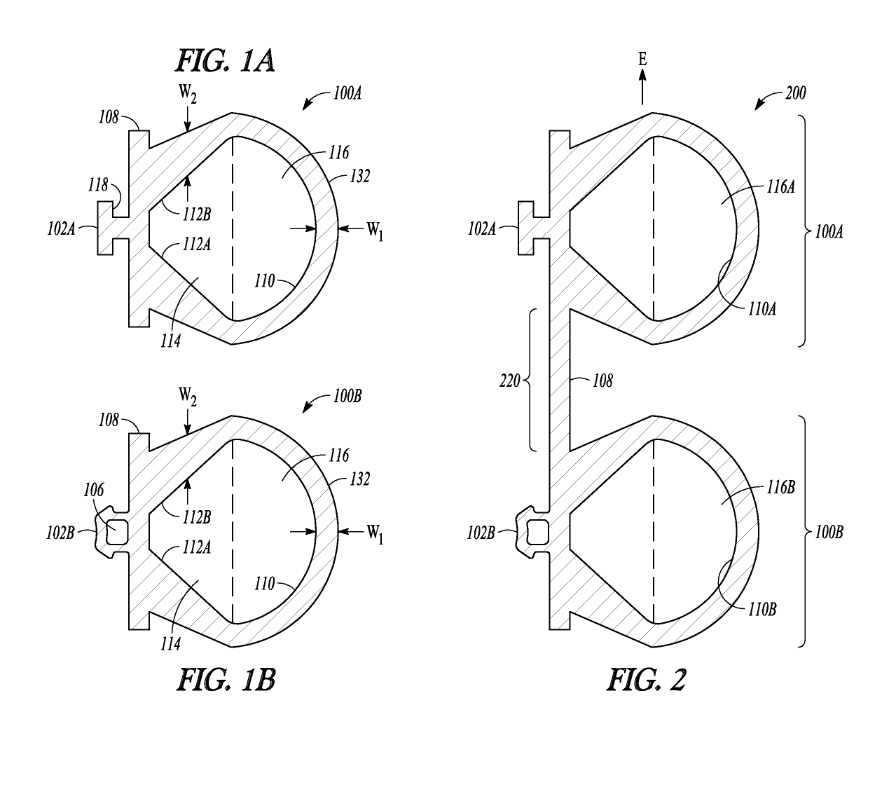

FIG. 1A illustrates generally an example of a cross-sectional profile of a flexible seal 100A, such as be included as a portion of a modular panel assembly and FIG. 1B illustrates generally an example of a cross-sectional profile of a flexible seal 100B, similar to the seal 100A of FIG. 1A but including an illustrative example of a retention feature 102B different from a retention feature 102A shown in the example of FIG. 1A. In the examples of FIGS. 1A and 1B, the flexible seals 100A or 100B can include a base region 108 coupled to a seal region defining a hollow cavity. The flexible seals 100A or 100B can be formed from a flexible material, such as an elastomer. The flexible seals 100A or 100B can include a silicone material or one or more other flexible materials such as natural or synthetic rubber (e.g., butyl rubber), or neoprene, for example. The flexible seals 100A or 100B can have a cross section width that is non-uniform, such as having a thicker width W₂ in a region near the base region 108, and a narrower width W₁ in a distal region 132 extending outwards from the base region 108.

In an illustrative example, such as shown in FIGS. 1A, 1B, or other examples herein, the flexible seals 100A or 100B can include a curved face in a region exterior to the hollow cavity (e.g., at or near the distal region 132 such as to provide a deformable interface for contact with another surface). In the example of FIGS. 1A, 1B, or other examples described herein, the flexible seals 100A or 100B can include a width that tapers along a wall of the flexible seals 100A or 100B defining at least a portion of the hollow cavity 116. For example, in a region 114 within the hollow cavity (delineated by a dashed line) one or more of an interior-facing portion or an exterior-facing portion of the flexible seals 102A or 102B can include flat faces, such as a face 112A and a face 112B. Elsewhere, the flexible seals 102A or 102B can include a curved interior-facing portion 110. In this manner, the distally-extending portion of the flexible seals 102A or 102B can preferentially deform or compress, while a tapered-width region nearer the base can remain relatively more rigid. One or more of the exterior-facing or interior-facing curved faces can have a substantially constant radius of curvature.

The retention features 102A or 102B can mechanically retain a face of the base region 108 against another assembly, such as a frame assembly, and a combination of the rigidity of the tapered-width region and the retention features 102A or 102B can help to keep the face base region 108 firmly in contact with, for example, the frame assembly to prevent fluid leakage behind the seal. In the example of FIG. 1A, the retention feature 102A can include a “tee” shape, such as to be retained by a channel in a frame assembly as shown elsewhere herein. Other retention feature shapes can be used, such as an “L” shape, and more than one retention feature can be included as a portion of the seal assembly, such as shown in FIG. 2 and other examples. In the example of FIG. 1B, the retention feature 102B includes tabs and a hollow region 106. The configuration of the retention feature 102B can deform slightly, such as during insertion into a corresponding cavity or channel in a frame assembly. In an example, such as after insertion, the tabbed features can be urged outwards (such as by a shape-memory or springing effect of an elastomeric material comprising the flexible seal 100B), such as to securely retain the flexible seal 100B against the frame assembly.

While examples shown in FIGS. 1A, 1B, or elsewhere herein include mechanical retention features to anchor a flexible seal to a mechanical frame, other techniques can be used in addition or instead of such features such as one or more of an adhesive, an adhesive tape (e.g., double-sided adhesive tapes), a thermo-forming technique, a thermal bonding technique, co-extrusion, and the like.

FIG. 2 illustrates generally an example of a cross-sectional profile of a flexible seal assembly 200, such as including a first seal 100A region and a second seal 100B region, and respective retention features located on a face of a base 108 opposite the first and second seal 100A and 100B regions. One or more retention features could be located elsewhere, such as elsewhere along the base 108. The profiles shown in the first and second seal 100A and 100B regions can be substantially similar or identical, such as similar to the examples shown in the examples of FIGS. 1A and 1B. For example, each of the seal 100A and 100B regions can be symmetric across a bisecting axis extending outwards through each seal 100A and 100B from the base region, and the entire seal assembly 200 can be substantially symmetric with respect to a line extending outwards from a central region 220 of the base 108, but such as with the exception of having different retention features. In the illustrative example of FIG. 2, the seal assembly 200 is precluded from being attached to the frame assembly in an incorrect orientation at least in part using differing retention features, because a retention feature 102B can be configured such that it cannot penetrate into a cavity shaped instead to receive the retention feature 102A.

The present inventor has recognized, among other things, that using two seal regions laterally offset from each other as shown in the example of FIG. 2, and elsewhere herein, can provide enhanced performance, such as prevent wind or moisture migration from a region of the seal facing outwards towards the exterior environment indicated by an axis E when the seal is located, for example, along a perimeter of a panel included in a modular panel system.

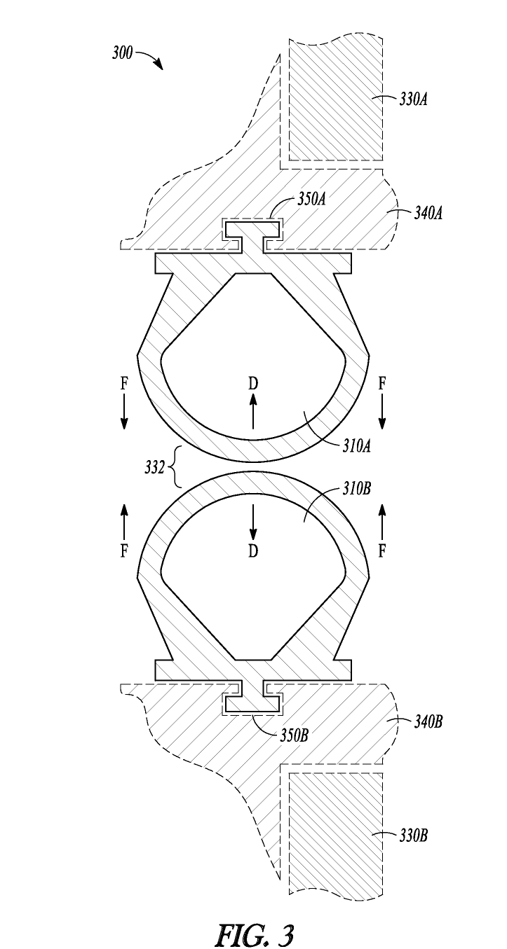

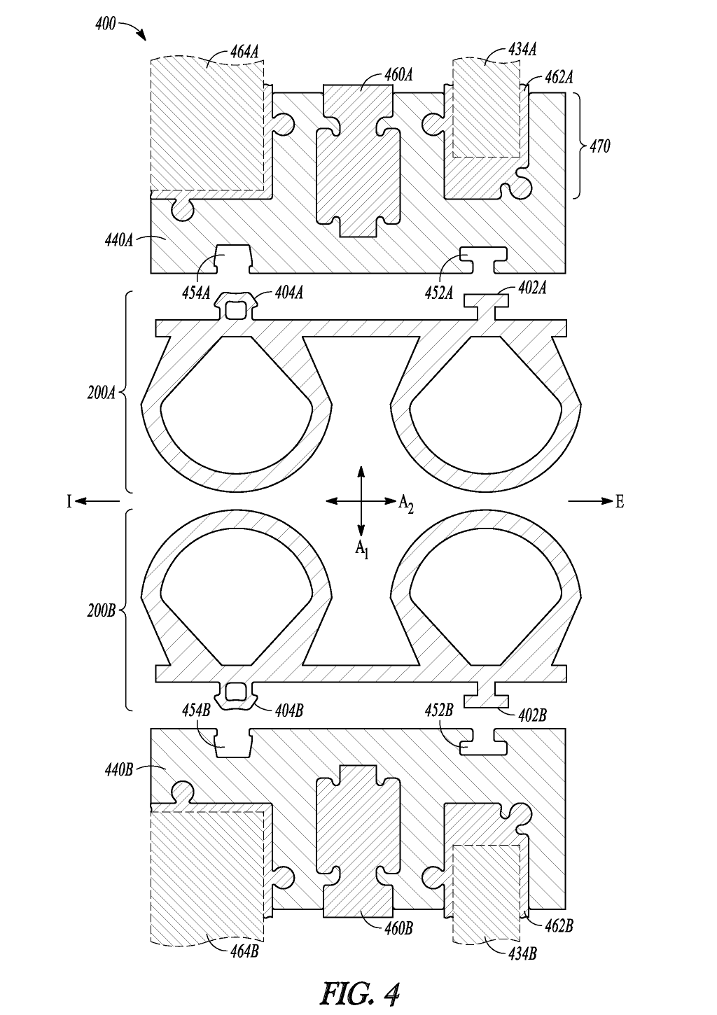

FIG. 3 illustrates generally an example of a cross-sectional view of a system 300 that can include two mechanical frame structures 340A or 340B, such as configured to retain respective flexible seals, such as similar to the flexible seal 102A as shown in FIG. 1A or other examples. The flexible seals can be retained, such as in respective channels 350A or 350B, such as can be included as a portion of the mechanical frame structures 340A or 340B. For example, the mechanical frame structures 340A or 340B can be fabricated using one or more of an extrusion, machining, or casting process, such as comprising aluminum, magnesium, titanium, or one or more other materials, including alloys or combinations thereof. As shown in the example of FIG. 4, the mechanical frame structures can include one or more regions configured to provide one or more of a thermal break (e.g., reducing a rate of heat transfer or suppressing heat transfer through, for example, a cross section of the frame structure). The frame structures 340A or 340B can be coupled to one or more panels 330A or 330B, such as a panel stack-up including one or more metallic, composite, or natural materials, or including glazing. For example, the mechanical frame structures 340A or 340B can form a perimeter frame of a pre-fabricated panel assembly.

During or after installation, the flexible seals can be compressed together in a loaded configuration such that forces applied in the direction indicated by the lines F cause corresponding displacements in the faces 332 of the flexible seals in the opposite direction indicated by the lines D, as the flexible seals are compressed together. After being pressed together in the loaded configuration, a mirror-image symmetry between the seals across the region 332 (which is closed after such loading) and the compressible, curved faces of the seals generally provides a weather-tight configuration that remains sealed even if the seals are displaced towards each other, away from each other, or if the seals are displaced in other axes (into or out of the page or left-to-right with respect to the orientation shown in FIG. 3).

FIG. 4 illustrates generally an example of a cross-section view of a system 400 that can include two mechanical frame structures 440A or 400B configured to retain respective flexible seal assemblies 200A or 200B. As in the examples of FIGS. 2 and 3, or other examples, the flexible seal assemblies 200A or 200B can include retention features of a first type 404A or 404B and a different second type 402A or 402B. Corresponding channels or cavities such as one or more of channels 454A, 454B, 452A, or 452B can be configured to mate with the retention features. As an illustrative example, the first seal assembly 200A can include two seal regions (e.g., as discussed in relation to FIG. 2), and can include different retention features so that the first seal assembly 200A is precluded from being attached in an incorrect orientation. For example, the retention feature 402A can be slid into the channel 452A (e.g., in a direction into or out of the plane shown in FIG. 4), and the retention feature 454A can be “snapped” into place, to securely anchor the first seal assembly 200A.

Use of a pair of seal regions (or even more than two seal regions) can help to provide redundancy and can assist in isolating moisture or wind from penetrating across the seal faces from an exterior-facing side (indicated by the line E) and an interior-facing side (indicated by the line I). The flexible seal regions can be compressed against their mirror-image counterparts as discussed in relation to the single-seal example of FIG. 3. As an illustrative example, for flexible seal assemblies 200A and 200B each having a base width of about 2.8 inches, where the widest portion (e.g., at the transition from tapering width to curved face) of each seal cross section is about 1.3 inches, when compressed together such seal assemblies performed without moisture leakage during negative pressure testing to beyond about 15 pounds per square foot (PSF), and such an illustrative configuration can maintain misalignment or displacement of about 0.75 inches in all directions (e.g., in a direction of axis A1, in a direction of axis A2, or in a direction of into or out of the plane of FIG. 4).

As in the example of FIG. 3, the mechanical frame structures 440A or 440B can be fabricated using variety of techniques. In the illustrative example of FIG. 4, the mechanical frame structures 440A or 440B can include one or more thermal breaks. A cavity or channel establishing such a thermal break can be filled with a less thermally-conductive material. For example, the mechanical frame structures 440A or 400B can be metallic, and one or more inserts such as an insert 460A or an insert 460B can include a polymer material. Such inserts can be co-extruded during fabrication of the mechanical frame structures 440A or 400B, or installed during assembly. For example, such inserts 460A or 460B can include polyethylene, and can provide better thermal isolation between the interior and exterior faces than a solid metallic frame structure. The inserts 460A or 460B can also contribute to structural rigidity and load-bearing capacity of the mechanical frame structures 440A or 440B. Other materials can be used for the inserts 460A or 460B, such as open or closed cell foam materials, a polyamide material, or one or more other materials.

The mechanical frame structures 440A or 440B can include other thermal break features, which can also be located within or near regions where a panel is attached or otherwise coupled to the mechanical frame structures 440A or 440B. For example, one or more of a panel 434A or 434B can be coupled to a respective mechanical frame structure 440A or 400B. A gasket or seal material 462A or 462B can be inserted in a cavity to one or more of provide a further thermal break, seal around the interface between the panel 434A or 434B and the corresponding mechanical frame structure 440A or 440B, or protect the panel 434A or 434B from excessive stress or damage (e.g., such as when the panel includes glass). The mechanical frame structures 440A or 440B can be coupled to other structures 464A or 464B such as another panel (e.g., an interior-facing panel), or to anchoring structures configured to support a modular panel assembly.

In an illustrative example, a modular panel assembly can be fabricated, such as having a perimeter including a frame-and-seal assembly having a cross-sectional configuration as shown in the examples above. The system 400 as shown in FIG. 4 illustrates generally an interface between two such perimeter frame-and-seal assemblies, such as located on panels adjacent to each other. When installed, as mentioned in FIG. 3, such panels would be configured to load the flexible seal assemblies 200A and 200B slightly into compression. In this manner, a seal is maintained even if the flexible seal assemblies 200A and 200B are displaced away from each other (which would otherwise open a gap).

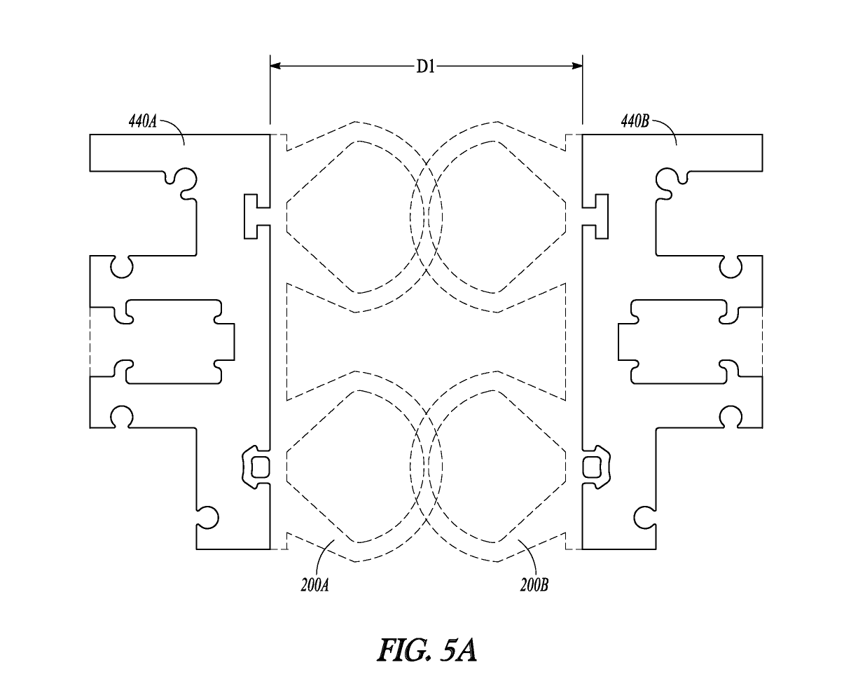

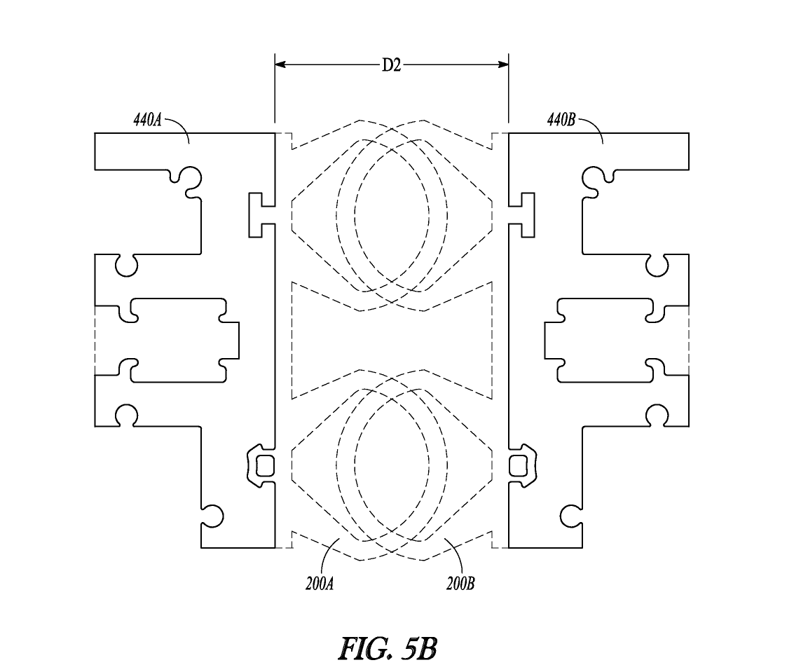

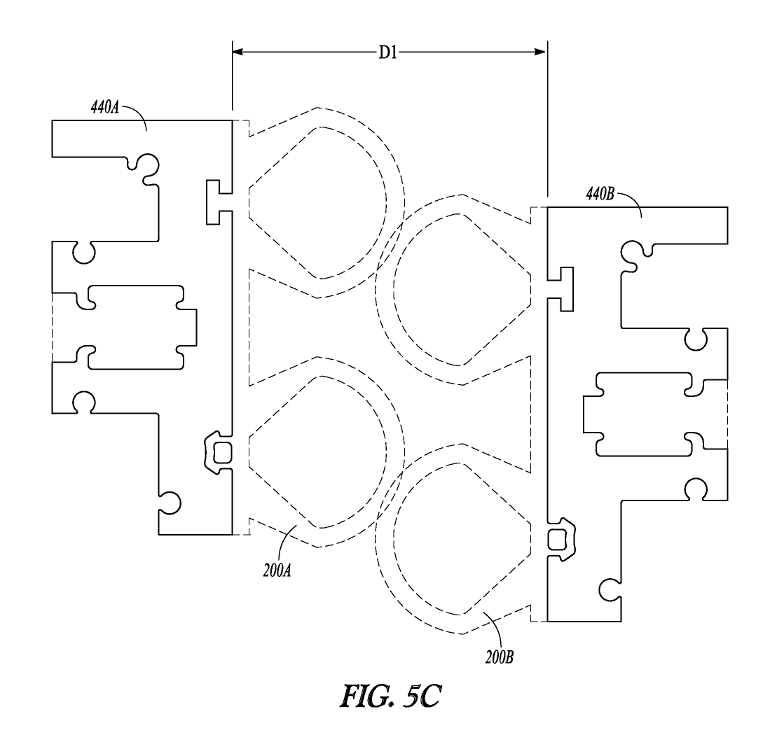

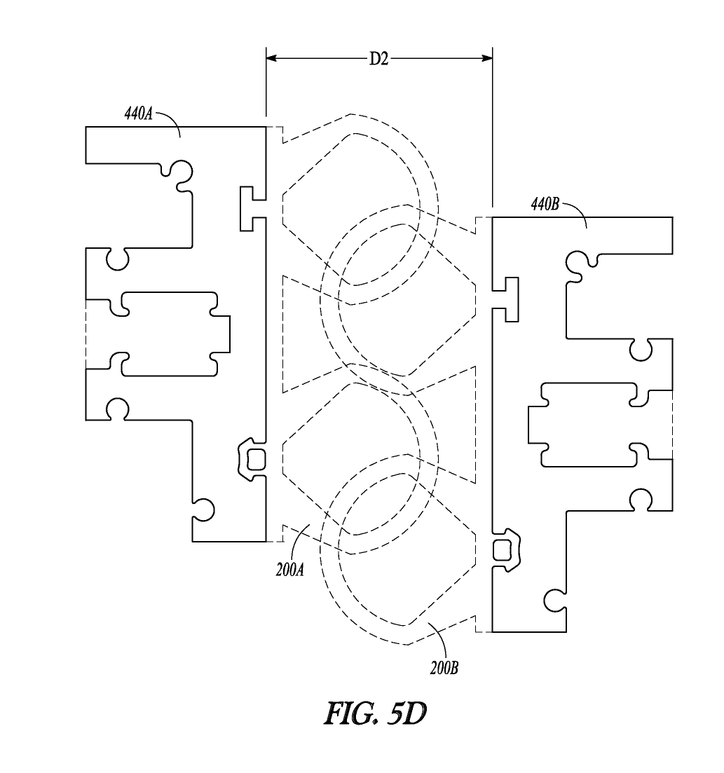

FIGS. 5A through 5D illustrate various relative alignments of a system that can include two mechanical frame structures 440A and 440B configured to retain respective flexible seals 200A and 200B. As in the illustrative example of FIG. 4, the flexible seals 200A and 200B can be mechanically coupled (e.g., attached or installed) to the respective mechanical frame structures 440A and 440B. A variety of relative alignments are shown in FIGS. 5A through 5D. In FIG. 5A, a distance D1 between the frame structures 440A and 440B still provides contact between both protruding portions of the seal assemblies (e.g., with such displacement occurring in the dashed regions of the seal assemblies 200A and 200B shown as overlapping). In the regions where the seal assemblies contact each other, both seal assemblies can be symmetrically displaced because each seal assembly includes a hollow region. For example, the gap D1 between the frame assemblies can be, in an illustrative example, about 1.5 inches. In FIG. 5B, the seal assemblies 200A and 200B can be displaced toward each other slightly as compared to FIG. 5A, such as having a distance D2 of about 1.125 inches. In both cases, contact between the seal assemblies 200A and 200B is maintained. Similarly, in FIGS. 5C and 5D, a displacement in an axis orthogonal to the displacement shown in FIG. 5B is shown. In each of the examples of FIGS. 5C and 5D, contact is maintained between the seal assemblies 200A and 200B despite misalignment. Such contact can be maintained as mentioned in other examples in part by using a deformable semi-circular or arc-shaped profile for portions of the seal assemblies 200A and 200B. In the manner shown in FIGS. 5A through 5D, for example, seal assemblies 200A and 200B, such as installed on panel assemblies adjacent to each other, can provide a “self healing” behavior because such seal assemblies provide weather-tight and wind-resistant sealing action even in the presence of displacements between the panels in multiple axes.

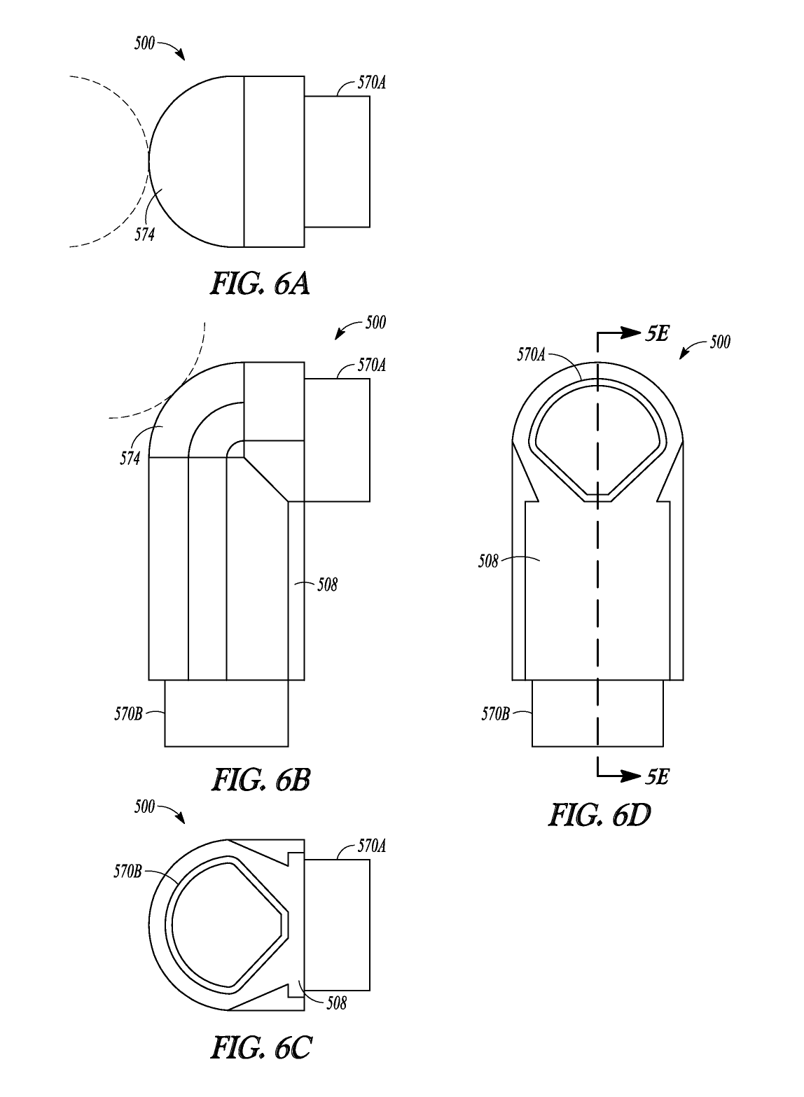

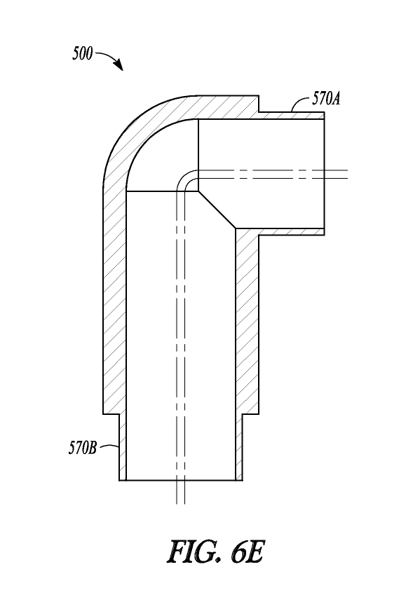

FIGS. 6A through 6D illustrate generally an example of a various views of a corner flexible seal assembly 500, and FIG. 6E illustrates generally an example of a cross-section view of such a corner flexible seal assembly 500, such as can be used to provide a weather-tight seal at a corner transition of a panel assembly, such as mating with respective flexible seal regions as shown in one or more of the examples of FIG. 1A, 1B, 2, 3, 4, or 5A through 5D. The corner flexible seal assembly 500 can include portions 570A and 570B, such as to made with corresponding hollow cavities defined by the flexible seal assemblies of FIGS. 1A, 1B, 2, or other examples. For example, the portions 570A and 570B can provide an interference fit when slid inside a corresponding hollow portion of another seal assembly. At a corner transition, a base portion 508 of the corner flexible seal assembly 500 can be sized and shaped similar to the dimensions of a base 108 or 208 of the flexible seal assemblies discussed elsewhere herein. A corner region 574 of the corner flexible seal assembly 500 can include a compound curved profile, such as to provide a spherical surface when uncompressed. A nearby corner region (dashed) of another flexible seal assembly can be compressed against the corner region 574 to load the corner region 574 in a similar manner to the examples discussed above, providing a weather-tight configuration that can remain sealed despite displacement in any direction. The cross-section view of FIG. 6E illustrates generally that the walls of the flexible corner seal assembly 500 can vary in thickness such as to provide the mating portions 570A or 570B, and respective centerlines through cavities defined by each of the mating portions 570A and 570B can be slightly offset from each other as shown.

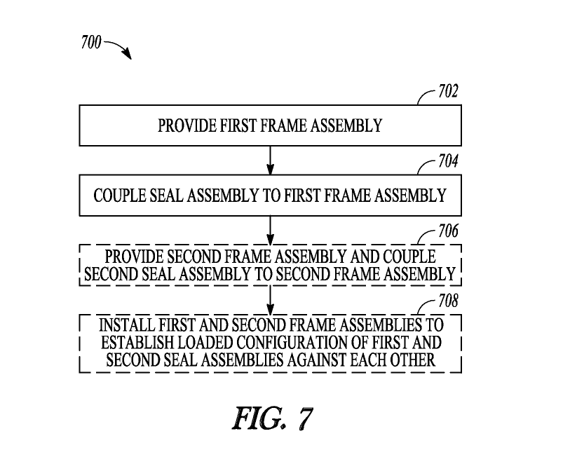

FIG. 7 illustrates generally a technique 700, such as a method, that can include coupling a flexible seal assembly to a frame assembly. At 702, a first frame assembly can be provided. The first frame assembly can include a channel sized and shaped to receive a retention feature of a seal assembly, such as to prevent the seal from detaching from the first frame assembly when the seal is displaced in at least one axis. At 704, a first flexible seal assembly can be coupled to the frame assembly. The first flexible seal assembly can include features such as shown and described in other examples herein.

Optionally, at 706, a second frame assembly can be coupled to a second flexible seal assembly. Optionally, at 708, the first and second frame assemblies can be installed on a structure, such as in a configuration that presses curved faces of the first and second seal assemblies together in a loaded configuration as shown and described in other examples herein.

### VARIOUS NOTES & EXAMPLES

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A flexible seal assembly, comprising:
a base region coupled to a first seal region defining a hollow cavity, the first seal region having a profile including a cross sectional width that is tapered in a tapered-width region near the base region to be thicker than in a distal region extending outwards from the base region;
wherein the profile of the first seal region includes a curved face in a region exterior to the first hollow cavity in the distal region extending outwards from the base region; and
wherein the profile of the first seal region includes flat faces in the region exterior to the first hollow cavity in the tapered-width region.

2. The flexible seal assembly of claim, wherein the first seal region includes flat faces facing an interior of the hollow cavity, in the tapered-width region.

3. The flexible seal assembly of claim 1, wherein the curved face includes a constant radius of curvature.

4. The flexible seal assembly of claim 1, wherein the profile of the first seal region includes a curved face facing an interior of the hollow cavity, coincident along the profile with the region having the curved face facing the exterior of the hollow cavity.

5. The flexible seal assembly of claim 1, wherein the base region comprises a first retention feature having a profile configured to mechanically retain the seal assembly in a mechanical frame.

6. The flexible seal assembly of claim 5, wherein the retention feature includes a flanged portion configured to slide into a corresponding channel of the mechanical frame.

7. The flexible seal assembly of claim 5, wherein the retention feature includes one or more tabs to snap into place into a corresponding channel of the mechanical frame.

8. The flexible seal assembly of claim 7, wherein the retention feature defines a second hollow cavity permitting displacement of a portion of the retention feature during insertion into the mechanical frame, but which urges the one or more tabs outwards after insertion to retain the flexible seal assembly in the mechanical frame after insertion.

9. The flexible seal assembly of claim 1, wherein the profile of the first seal region is symmetrical about a bisecting axis extending towards the distal region from the base region.

10. The flexible seal assembly of claim 1, comprising a second seal region having a profile matching the first seal region, coupled to the base region but laterally offset from the first seal region.

11. The flexible seal assembly of claim 10, wherein the base includes a first retention feature located on the base region opposite the hollow cavity of the first seal region and a second retention feature located on the base region opposite a hollow cavity of the second seal region.

12. The flexible seal assembly of claim 11, wherein the first and second retention features are different to preclude attachment of the flexible seal assembly in an incorrect orientation.

13. A flexible seal assembly, comprising:
a base region coupled to a first seal region, defining a hollow cavity, the first seal region having a profile including a cross sectional width that is tapered in a tapered-width region near the base region to be thicker than in a distal region extending outwards from the base region;
a second seal region having a profile matching the first seal region, coupled to the base but laterally offset from the first seal region;
wherein the profile of the first seal region includes a curved face having a constant radius of curvature in a region exterior to the first hollow cavity in the distal region extending outwards from the base region;
wherein the profile of the first seal region includes flat faces in the region exterior to the first hollow cavity in the tapered-width region;
wherein the first seal region includes flat faces facing an interior of the hollow cavity, in the tapered-width region; and
wherein the base includes a first retention feature located on the base region opposite the hollow cavity of the first seal region and a second retention feature located on the base region opposite a hollow cavity of the second seal region; and
wherein the first and second retention features are different to preclude attachment of the flexible seal assembly in an incorrect orientation.

14. A system, comprising:
a first flexible seal assembly including:
a base region coupled to a first seal region defining a hollow cavity, the first seal region having a profile including a cross sectional width that is tapered in a tapered-width region near the base region to be thicker than in a distal region extending outwards from the base region;
a retention feature located on the base region opposite the hollow cavity;
a first frame assembly including a channel sized and shaped to receive the retention feature and configured to inhibit the seal assemble from detaching from the first frame assembly when the seal is displaced in at least one axis, the first frame assembly configured to couple to a panel;
wherein the profile of the first seal region includes a curved face in a region exterior to the first hollow cavity in the distal region extending outwards from the base region; and
wherein the profile of the first seal region includes flat faces in the region exterior to the first hollow cavity in the tapered-width region.

15. The system of claim 14, wherein the first frame assembly comprises a metal extrusion; and
wherein the first frame assembly defines a thermal break cavity located along the first frame assembly.

16. The system of claim 15, comprising an polymer-based insert configured to be securely retained in the thermal break cavity.

17. The system of claim 16, wherein the insert comprises polyethylene.

18. The system of claim 14, wherein the frame assembly includes a cavity configured to be coupled to the panel, the cavity also including a thermal break.

19. The system of claim 14, comprising a second frame assembly coupled to a second flexible seal assembly, the second flexible seal assembly having a profile comprising a substantially-mirror-image representation of the first flexible seal assembly.

20. The system of claim 19, wherein the first seal assembly comprises a first pair of respective hollow seal regions having matching profiles, each coupled to the base but laterally offset from each other along the base; and
wherein the second seal assembly comprises a second pair of hollow seal regions having a profile comprising a substantially-mirror-image representation of the first flexible seal assembly.
